(19) United States
(12) Patent Application Publication
(10) Pub. No.: US 2006/0035097 A1
(43) Pub. Date: Feb. 16, 2006

(54) Antimicrobial coating composition and treated building construction materials therewith

(76) Inventor: Vernon H. Batdorf, Minneapolis, MN (US)

Correspondence Address: Vernon H. Batdorf, 5014 41st Avenue South, Minneapolis, MN, 55417, US

(21) Appl. No.: 10/918,607

(22) Filed: Aug. 12, 2004

(51) Int. Cl. B32B 13/00; B32B 27/00; C09D 5/14; B32B 27/06

(52) U.S. Cl. 428/507; 428/500; 428/703; 428/537.1; 428/294.7; 106/15.05

(57) ABSTRACT

The present invention concerns an antimicrobial composition, a process for making antimicrobial building construction surfaces, and building construction products treated with the composition on their surfaces. The water based antimicrobial composition disclosed comprises a water resistant polymer, at least three organic based antimicrobial agents, with at least one antimicrobial agent being halogen containing, and at least one antimicrobial agent being non-halogen containing. The composition is useful for treating the surfaces of building construction materials to make products that are highly resistant to microbial growth even in severe environments.

### BACKGROUND OF THE INVENTION

1. Field of the Invention

The invention relates to a method of protecting building construction material surfaces from the growth of microbes by the application of a water based composition onto the material surfaces.

2. Prior Art

Problems with mold growth in building construction materials is becoming more frequent with the changes being made for higher energy efficiency. Buildings are now typically constructed with vapor barriers on the exterior walls behind the final cladding in warm humid climates, and with the vapor barrier behind the interior wall facing material in cold climates. However, air leaks in the constructed wall allow for moisture ladened air to pass into the wall cavity where it can condense either within the cool insulation or on the interior side of the vapor barrier when the cool surfaces are below the dew point. Once elevated moisture conditions exist within the wall cavity, mold can quickly grow on supportive cellulosic surfaces like structural wood or paneling, paper facings or on gypsum wall board. Mold growth can also occur during construction when building materials are exposed to the weather for several months, and become damp or wet for an extended time from moisture absorption due to rain or ground moisture. Mold growth on building surfaces is now a source of fear for building occupants due to media coverage on people contacting mold related illnesses from exposure to mold spores and toxins in contaminated buildings.

The building construction materials market is a highly competitive commodity market that drives down the cost of the manufactured materials. Attempts are being made to provide some mold growth protection to the construction materials by incorporating low cost antimicrobial compounds like copper compounds, sodium borates, or alkyl ammonium chloride quaternary compounds into the materials. However, these mold resistant materials to date have only marginal resistance to mold growth, and do not protect the material surface in severe growth conditions as found in water damaged buildings. Many of the antimicrobials are also water soluble, like the sodium borates and other inorganic salts, and are easily leached out of the treated material. Some other antimicrobials like ionic silver compounds, copper compounds, or alkyl ammonium chloride quaternary silane are being promoted as effective against bacteria growth, but have poor resistance to mold or fungal growth, and are extremely expensive. Current effective mold protection is available, however the antimicrobial compositions are either deemed too costly a solution to allow maintaining a competitive position in the market place, or are too hazardous to use in occupied buildings, or lose their effectiveness over time, or are incompatible with the building material manufacturing process. No one antimicrobial has been found by the inventor that can protect against all mold or fungal growth in severe wet or damp conditions within a cost acceptable range of about 3.0 to 10.0 grams active/100 ft2 of treated surface.

Publication No.: US 2003/0096545 A1, May 22, 2003 claims a sporicidal composition containing a pyrithione antimicrobial and at least 100 ppm of a iodine containing antimicrobial, which can be incorporated into various products like HEPA filters, paint, and textile fabrics. In particular it teaches the use of zinc pyrithione with diiodomethyl-4-tolylsulfone in ratios of 7:1 to 1:1 by weight as a sporacide to protect HEPA filters or paper products. The disadvantage of this invention is the need to use 3-50% by weight binder on the web substrate, resulting in a high application and product cost for building construction materials. It also calls for 0.28% by weight antimicrobial agents on the total weight of the substrate, which results in a cost per unit surface area that is beyond what normally would be acceptable to building construction material manufacturers. Another disadvantage is that it is limited to the use of iodine containing compounds with various pyrithione compounds, and does not incorporate the value of using at least three antimicrobials to obtain multifunctional activity against microbes, nor the value of using other halogen containing antimicrobial compounds other than iodine, nor non-halogen containing antimicrobial compounds other than pyrithione types, nor the value of using water resistant polymers to minimize moisture content below the required content for microbial growth.

U.S. Pat. No. 5,744,239, Apr. 28, 1998 teaches the use of one or more different antimicrobial compounds to inhibit the growth of bacteria or fungus on pavement markings or the adhesives used to adhere them to the pavement. It teaches the use of either halogen or non-halogen containing antimicrobial agents. The disadvantage of this invention is that the antimicrobial agents have to be incorporated into the material to be protected (primer, adhesive, or pavement marking), or sprayed onto the surface of the adhesive or pavement marking without being pre-incorporated into a water resistant polymer to keep them affixed to the surface throughout the marking service life. Neither does this invention provide a zone of inhibition against mold or fungus, and thereby would allow microbial growth on deposited organic debris on the surface of the pavement marking.

U.S. Pat. No. 6,299,520 B1, Oct. 9, 2001 describes a scrubbing pad comprising a web of non-woven fibers coated thereon with a mixture of antimicrobial agents dispersed in a curable binder to anchor the antimicrobial agents to the fibers and prevent them from being leached. The disadvantages of this invention are that it requires the use of cross-linking agents to obtain a curing of the binder at a temperature of about 250° F. Another disadvantage is that it requires at least an equal weight of the coating composition to the weight of the web of fibers it is coated upon. An antimicrobial coating on building construction materials needs to be significantly less in weight than the construction material weight.

Therefore there remains a need for a long term cost effective prevention of mold growth on building construction materials.

### SUMMARY OF THE INVENTION

The invention comprises a water based antimicrobial composition containing a water based binder and at least three different organic based antimicrobial agents comprising of at least one halogen containing antimicrobial agent, and at least one non-halogen containing antimicrobial agent, and at least one other antimicrobial agent that is either halogen or non-halogen containing. The water based binder encapsulates and secures the antimicrobial agents to the construction material surface, insuring their presence throughout the service life. The water based binder also inhibits water absorption into the building construction material and thereby minimizes opportunity for mold, fungus or algae growth which require a minimum moisture content for growth. The invention also comprises a process for treating various building construction material surfaces by the application of the water based composition to at least one surface of the construction material. The invention also comprises articles that are formed by the process of applying the water based antimicrobial composition to at least one surface of the building construction materials. The articles thus formed have the advantage of resisting microbial growth on their surfaces throughout their useable service life. The main advantage of the invention is that it can be used at very high coverage rates on mold susceptible building construction surfaces with excellent inhibiting of microbial growth. High coverage rates gives the user the advantage of lower application and product costs per unit area, fast dry time for immediate stacking or installation of treated panels, and no visual change in the treated surface appearance other than color if desired. It has been found that the use of at least one organic based halogen containing antimicrobial agent with at least one organic based non-halogen containing antimicrobial agent provides a synergism against microbial growth on treated surfaces through duel functional activity. When at least three organic based antimicrobial agents are used, multifunctional antimicrobial activity is obtained, allowing microbial efficacy at very high coverage rates of the composition, even to 2000 ft2 per gallon.

### DETAILED DESCRIPTION OF THE INVENTION

The water based binder includes at least one water resistant polymer, which will remain firmly adhered to the treated surface when exposed to prolonged wet conditions. Suitable water based binders for the protective barrier coating composition include polyvinyl acetate emulsions, terpolymers of vinyl acetate-vinyl chloride-ethylene emulsions, flexible ethylene-vinyl chloride copolymer emulsions, styrene butadiene rubber emulsions, vinyl acrylate or acrylic copolymer emulsions, 100% acrylic, styrene acrylic emulsions, chloroprene emulsions, silicone resin dispersions, and combinations thereof. Examples of commercially available water based binders include Airflex ®500, 809, 728 and 4500 from Air Products, Flexbond® 670, 675, 325 and 381 from Air Products,_Styrofan® ND 565 or 422, Acronal 296D and NX4787 from BASF, Neoprene 115 from Dow—DuPont, and Raykote 1505 and 1610 from Specialty Polymers. These and other polymer emulsions can be used as long as they provide good wetting and adhesion to construction materials even under wet conditions, have good binding properties for the antimicrobial and inorganic components, good film formation at application temperatures, and good water resistance for the dried film. The water based binders form a film on drying at ambient conditions by the loss of water, and do not require the use of cross-linking agents nor the application of heat to obtain the desired properties. It is preferred that the water based binder polymer content be from about 5% to about 40% by weight, more preferred from about 8% to about 30%, and most preferred from about 10% to about 25% of the total composition weight.

The antimicrobial agents are chosen from those that are non-volatile solids with low water solubility of about no more than 100 ppm, and resistant to hydrolysis or heat degradation, and non-hazardous to building occupants when used in the composition. The antimicrobial agents are chosen from those that are registered with the Environmental Protection Agency (EPA) for use in paints, coatings, sealants, or adhesives, and used within the permitted use range in the formulated composition. It has been found that a synergism is obtained by choosing a blend of at least three different organic based antimicrobial agents, with at least one being halogen containing, and at least one being non-halogen containing, and a third different antimicrobial agent that can be either halogen or non-halogen containing. The result is an increase in the effectiveness of inhibiting microbial growth on a susceptible building construction material's surface, and therefore the formulated composition can be applied at a sufficiently high coverage rate of at least about 400 ft2/gallon on the building material to be treated to allow for the cost per unit area to be within the competitive cost restrictions. Compositions of the invention have been found to be effective in preventing all mold growth on construction materials like lumber, oriented strand board (OSB), wafer board, plywood, fiber board, laminated beams, composites of wood and plastic, particle board, acoustical ceiling tile, or paper facings on gypsum wall board. The composition of this invention provides a zone of inhibitation of at least about 5 mm when tested by the standard test method ASTM D 5590, thereby protecting the treated surface even when contaminated with organic debris. Coverage rates of about 400 ft2/gallon to 2000 ft2/gallon have been achieved using these compositions, or a total active fungicidal compound level of as low as about 3.0 grams active per 100 ft2 of treated surface area, and as low as about 0.20% weight of the dried composition on the treated material. At these high coverage rates, or low antimicrobial use levels, the cost for surface treating the construction material becomes within the acceptable range for maintaining competitive pricing. It also results in a minimal application of water per unit area from the composition, which allows for quick surface dry for the immediate stacking of treated building panels at the panel manufacturing plant without the panels adhering to one another after fully drying. The high coverage rate of the composition on the treated panels also minimizes energy requirements for drying, and the ventilation requirements to eliminate objectionable odors.

Various combinations of at least three(3) of the following organic based antimicrobials have been found effective at as low as 3.0 grams total actives per 100 ft2 of treated surface area in ratios of any one antimicrobial agent being at least 5% by weight of the total antimicrobial weight, but no more than the weight percent usage in the composition as limited by the EPA. The EPA registered maximum usage level varies, but normally is at about 0.50%, with a few up to 1.0% by weight active for any one antimicrobial agent. It is preferred that the antimicrobial agent content in the composition for each of at least three organic based antimicrobial agents be from about 0.05% to about 1.0% by weight, and most preferred from about 0.10% to 0.80% by weight. Building construction material surfaces are preferably treated with the composition at less than about 3.0% by weight of dried composition on the treated material, and more preferably less than about 1.0% by weight. The following combinations have been found to have exceptional performance against a broad range of mold and fungus, and in most cases also against algae and bacteria, with higher activity than either antimicrobial compound by itself. The preferred halogen containing organic based antimicrobial agents to use are IPBC (Iodo-propynyl butyl carbonate), Amical® 48 and Amical® Flowable (diiodomethyl-p-totylsulfone) from Dow Chemical, Rozone™ 2000 (4,5-dichloro-2-n-octyl-4-isothiazolin-3-one) from Rohm & Haas, Prevental A8 (Tebuconazole) from Bayer Corporation, and Busan® 1192-D (Chlorotholonil) from Buckman Labs. The IPBC is only used when less than about 7 years service life is required, as it will slowly breakdown from hydrolysis, heat and UV exposure. The preferred non-halogen containing organic based antimicrobial agents are Zinc Omadine® (Zinc pyrithione) and Sodium Omadine® (Sodium salt 2-pyridinethiol-1-oxide)(along with zinc oxide) from Arch Chemical, Skane® M-8 (2n-octyl-4-isothiazolin-3-one) from Rohm & Haas, Vancide® MZ96 (Zinc dimethyl dithiocarbamate) from R. T. Vanderbelt, Mergal® BCM and Mergal® S-90 from Troy Chemical Co. Because the Sodium Omadine® is water soluble by itself, it is used only in a complexed form with zinc oxide of at least two moles zinc oxide per mole of Sodium Omadine® to obtain the very low water solubility needed for long term microbial protection.

The composition may include other additives such as dispersants, surfactants, thickeners, pigments, mineral fillers, defoamers, biocides, cross-linkers, plasticizers, coalescants, freeze-thaw stabilizers and adhesion promoters. The choice of these additives is dependent upon the particular application method, service requirements, manufacturing methods, and substrates treated, each used as chosen by one skilled in the art of formulating paints, coatings, adhesives or sealants.

### EXAMPLES

One test procedure used in the examples is ASTM D-5590. It is a test procedure for testing paints or coatings for resistance to growth of various fungus on it surface. The method uses a potato dextrose agar nutrient. The test specimens are set on the agar in petri dishes and inoculated with a fungal culture of Aspergillus Niger (ATCC 6275), Penicillium funiculosum ATCC 17797), and Aureobasidium pullulans (ATCC 9348). The specimens are incubated at 28 degrees C under 85% to 90% relative humidity for 4 weeks, and noted for visual growth. Rating is 0 for none, 1 for a trace of growth (<10% over surface), 2 for light growth (10%-30%), 3 for moderate growth (30%-60%), and 4 for heavy growth (60% to complete coverage). The coating coverage rate used on the specimens is reported. In this invention, the coverage rate is tested at about 400 to 2000 ft2/gallon.

Another test method used in the examples is ASTM D-3273. It is a test method that describes a small environmental chamber and the conditions of operation to evaluate reproducibly in a 4-week period the relative resistance of paint film (or other surfaces) to mold fungi or mildew growth in a severe interior environment. This method is intended for the accelerated evaluation of an interior coating's resistance to fungal defacement. The Environmental Chamber is maintained at a relative humidity of 95 to 98%. The water in it is kept at 32.5° C. with a submersible aquarium heater while the chamber itself is kept at room temperature. A stainless steel tray with a mesh bottom is filled with potting soil/peat moss mix (pH=7.0) and supported in the water so it sits 1 inch above the surface of the water. A pitched top is placed over the testing surface so moisture condensation will run down the sides and be circulated instead of dripping onto the test samples. The entire chamber is covered tightly to minimize water evaporation and maintain humidity. The test organisms used are Aureobasidium pullulans, ATCC 9348, Aspergillus niger, ATCC 6275, and Penicillium sp. 12667. Fungal cultures are grown on appropriate agar slants for 10-14 days, harvested and spread evenly over the surface of the moistened soil bed. The chamber is then allowed to equilibrate for 2 weeks while the fungi grow and sporulate. A rating of “10” is equivalent to No Growth, a “5” rating is equivalent to 50% growth over the surface, and a “0” rating indicates heavy confluent growth. All examples are tested at a coverage rate of about 400 to 2000 ft2/gallon on the treated surface.

### Example 1

Blend in the following components in order at room temperature in a clean mixing tank at the following weight percentages.

| | |
|---|---|
| Water | 45.0 |
| Cellulosic thickener | .2 |
| Nonionic surfactant | .3 |
| Titanium Dioxide | 10.0 |
| Styrene Acrylic emulsion (50% solids) | 40.0 |
| Coalescent solvent | 2.0 |
| Amical Flowable ® (40% active) | .8 |
| Rozone ™ 2000 (20% active) | .5 |
| Zinc Omadine ® (48% active) | 1.0 |
| Defoamer, oil based | .2 |
| Total | 100.0% |

Weight Solids: 31.6%
Weight per Gallon: 9.2 pounds

Results: Fungal resistance tested at 400 ft2 per gallon on 11/16 inch thick pine board, antimicrobial actives at 9.3 grams/100 ft2 of surface area. The weight of the dried composition is at about 0.52% of the pine board, and actives at about 0.015% of the total pine weight.
ASTM D 5590 Results:
Rating: Zero growth
Zone of Inhibition: up to about 23 mm
ASTM D 3273 Results:
Rating 10, no growth

### Example II

Blend in the following components in order at room temperature in a clean mixing tank at the following weight percentages.

| | |
|---|---|
| Water | 35.0 |
| Cellulosic thickener | .2 |
| Nonionic surfactant | .3 |
| Ionic dispersant | .3 |
| Titanium Dioxide | 8.0 |
| Mineral filler | 10.0 |
| Styrene Acrylic emulsion (50% solids) | 40.0 |
| Coalescent | 1.0 |
| Zinc Oxide | 2.0 |
| Sodium Omadine ® (40% solids) | 1.0 |
| Amical ® Flowable (40% solids) | 1.0 |
| IPBC-40 (40% solids) | 1.0 |
| Oil based defoamer | .2 |
| Total | 100.0% |

Weight solids: 42.3%
Weight per Gallon: 9.9 pounds

Results: Fungal resistance testing at a coverage rate of 1200 ft2/gallon on the paper facing of ⅜ inch thick gypsum wall board, total antimicrobial actives at 4.5 grams/100 ft2 of surface area, The weight of the dried composition at about 0.22% of the wall board. Actives are at about 0.006% of the total wall board weight.
ASTM D 5590 Results:
Rating: Zero growth
Zone of Inhibition: about 19 mm
ASTM D 3273 Results:
Rating: 10, no growth

### Example III

Blend in the following components in order at room temperature in a clean mixing tank at the following weight percentages.

| | |
|---|---|
| Water | 16.05 |
| Cellulosic thickener | .15 |
| Nonionic surfactant | .30 |
| Coalescent solvent | 1.80 |
| Zinc Oxide | 1.20 |
| Sodium Omadine ® (40% active) | .60 |
| Rozone 2000 ™ (20% active) | .50 |
| Preventol A8 (100% active) | .60 |
| Algaecide | 1.00 |
| UV absorber | 1.00 |
| Oil based defoamer | .20 |
| Acrylic emulsion (45% solids) | 62.00 |
| Coalescent | 1.40 |
| Mineral filler | 13.00 |
| Defoamer, oil based | .20 |
| Total | 100.00% |

Weight Solids: 47.0%
Weight per Gallon: 9.5 pounds

Results: Fungal resistance by ASTM D-5590 at 800 ft2/gallon on a cedar roof shake, total antimicrobial actives at 5.0 grams/100 ft2 of surface area. The dried composition weight is at about 0.90% of the shake. Actives are at about 0.018% of the total cedar roof shake weight.
Rating: Zero growth
Zone of Inhibition: about 21 mm

### Example IV

Blend in the following components in order at room temperature in a clean mixing tank at the following weight percentages.

| | |
|---|---|
| Water | 47.3 |
| Cellulosic thickener | .3 |
| Nonionic surfactant | .3 |
| Ionic dispersant | .3 |
| Iron Oxide pigment | 6.4 |
| Titanium Dioxide | 6.4 |
| Oil based defoamer | .2 |
| Zinc Oxide | 2.4 |
| Sodium Omadine ® (40% solids) | 1.2 |
| Zinc Omadine ® (48% active) | 1.0 |
| Amical ® flowable (40% solids) | 1.2 |
| Rozone ™ 2000 (20% solids) | .6 |
| Styrene Acrylic emulsion (50% solids) | 32.0 |
| Coalescent | .4 |
| Total | 100.0% |

Weight Solids: 35.0%
Weight per Gallon: 9.6 pounds

Results: Fungal resistance at 1600 ft2/gal on ½ inch thick OSB, total antimicrobial actives at 4.2 grams/100 ft2 of surface area. The dried composition weight is at about 0.13% of the OSB. Actives are at about 0.006% of the total OSB weight.
ASTM D 5590 Results:
Rating: Zero growth
Zone of Inhibition: about 10 mm
ASTM D 3273 Results:
Rating: 10, no growth

I Claim:

1. A water based antimicrobial composition comprising 1) a water based binder, and 2) at least three different organic based antimicrobial agents comprising a) at least one halogen containing antimicrobial agent, and b) at least one non-halogen containing antimicrobial agent, and c) at least one other halogen or non-halogen containing antimicrobial agent, the total antimicrobial agent amount being in sufficient amounts to inhibit growth of microorganisms on the treated surfaces of building construction materials.

2. The water based antimicrobial composition of claim 1, wherein any one organic based antimicrobial agent being at least about 5.0% by weight of the total antimicrobial weight.

3. The water based antimicrobial composition of claim 1, wherein the composition exhibits a fungal growth of no greater than one (1) when measured according to test method ASTM D-5590 on treated surfaces of a building construction material.

4. The water based antimicrobial composition of claim 1 wherein the halogen based antimicrobial agent is selected from the group consisting of diiodomethyl-4-tolylsulfone, 3-iodopropynylbutylcarbamate, 3-(3,4 dichlorophenyl)-1,1-dimethylurea, Triclosan, Tebuconazole, 4,5-dichloro-2-n-octyl-4-isothiazolin-3-one, and mixtures thereof.

5. The water based antimicrobial composition of claim 1 wherein the non-halogen based antimicrobial agent is selected from the group consisting of zinc pyrithione, sodium 2-pyridinethiol-1-oxide complexed with zinc oxide, 2n-octyl-4-isothiazolin-3, methylbenzimidazole 2yl carbamate, 2 methylthio-4-t-butylamino-6-cyclopropylamino-s-triazine, and mixtures thereof.

6. The water based antimicrobial composition of claim 1 wherein the water based binder is selected from the group consisting of vinyl acetate-ethylene emulsions, vinyl acrylic or acrylate-acrylenitrile copolymer emulsions, styrene acrylic emulsions, styrene butadiene rubber emulsions, acrylic homopolymer emulsions, ethylene-vinyl chloride copolymer emulsions, vinyl acetate-vinyl chloride-ethylene terpolymer emulsions, polyvinyl acetate emulsions, chloroprene emulsions, and combinations thereof.

7. The water based antimicrobial composition of claim 1 wherein the water based binder polymer content in the composition is from about 5% to about 40% by weight.

8. The water based antimicrobial composition of claim 1 wherein at least one halogen containing antimicrobial agent is present in an amount of from about 0.05% to about 2.0% by weight.

9. The water based antimicrobial composition of claim 1 wherein at least one non-halogen containing antimicrobial agent is present in an amount of from about 0.05% to about 2% by weight.

10. A process of treating a building construction material with the water based antimicrobial composition of claim 1 comprising the application of the composition to at least one surface of the construction material.

11. A process of claim 10, wherein the halogen containing antimicrobial agent is selected from the group consisting of diiodomethyl-4-tolylsulfone, 3-iodopropynylbutylcarbamate, 3-(3,4 dichlorophenyl)-1,1-dimethylurea, Triclosan, Tebuconazole, 4,5-dichloro-2-n-octyl-4-isothiazolin-3-one, and combinations thereof.

12. A process of claim 10, wherein the non-halogen containing antimicrobial agent is selected from the group consisting of zinc pyrithione, sodium 2-pyridinethiol-1-oxide complexed with zinc oxide, 2n-octyl-4-isothiazolin-3, methylbenzimidazole 2yl carbamate, 2 methylthio-4-t-butylamino-6-cyclopropylamino-s-triazine, and combinations thereof.

13. A process of claim 10, wherein the water resistant polymer is selected from the group consisting of vinyl acetate-ethylene emulsions, vinyl acrylic or acrylate-acrylenitrile copolymer emulsions, styrene acrylic emulsions, styrene butadiene rubber emulsions, acrylic homopolymer emulsions, ethylene-vinyl chloride copolymer emulsions, vinyl acetate-vinyl chloride-ethylene terpolymer emulsions, polyvinyl acetate emulsions, chloroprene emulsions, and combinations thereof.

14. An article comprising a building construction material which has at least one surface treated with the water based antimicrobial composition of claim one.

15. An article of claim 14, wherein said building construction material is selected from the group of oriented strand board, wafer board, gypsum wall board, lumber, pre-assembled building components made from lumber, and acoustical ceiling tile.

16. An article of claim 14, wherein the halogen containing antimicrobial agent is selected from the group consisting of diiodomethyl-4-tolylsulfone, 3-iodopropynylbutylcarbamate, 3-(3,4 dichlorophenyl)-1,1-dimethylurea, Triclosan, Tebuconazole, 4,5-dichloro-2-n-octyl-4-isothiazolin-3-one, and combinations thereof.

17. An article of claim 14, wherein the non-halogen containing antimicrobial agent is selected from the group consisting of zinc pyrithione, sodium 2-pyridinethiol-1 -oxide complexed with zinc oxide, 2n-octyl-4-isothiazolin-3, methylbenzimidazole 2yl carbamate, 2 methylthio-4-t-butylamino-6-cyclopropylamino-s-triazine, and combinations thereof.

18. An article of claim 14, wherein the water based binder is selected from the group consisting of vinyl acetate-ethylene emulsions, vinyl acrylic or acrylate-acrylenitrile copolymer emulsions, styrene acrylic emulsions, styrene butadiene rubber emulsions, acrylic homopolymer emulsions, ethylene-vinyl chloride copolymer emulsions, vinyl acetate-vinyl chloride-ethylene terpolymer emulsions, polyvinyl acetate emulsions, chloroprene emulsions, and combinations thereof.
